(19) United States
(12) Patent Application Publication
(10) Pub. No.: US 2020/0358092 A1
(43) Pub. Date: Nov. 12, 2020

(54) METHOD OF FORMING CHARGED MANGANESE OXIDES FROM DISCHARGED ACTIVE MATERIALS

(71) Applicant: RESEARCH FOUNDATION OF THE CITY UNIVERSITY OF NEW YORK, New York, NY (US)

(72) Inventors: Gautam G. YADAV, New York, NY (US); Xia WEI, New York, NY (US); Michael NYCE, New York, NY (US); Sanjoy BANERJEE, New York, NY (US)

(21) Appl. No.: 16/958,596

(22) PCT Filed: Dec. 28, 2018
(86) PCT No.: PCT/US2018/067880

§ 371 Date: Jun. 26, 2020

Related U.S. Application Data
(60) Provisional application No. 62/611,947, filed on Dec. 29, 2017.

(51) Int. Cl. H01M 4/50; H01M 4/62; H01M 10/44; H01M 2/16; H01M 4/36

(52) U.S. Cl. CPC H01M 4/50; H01M 4/625; H01M 4/362; H01M 2/1653; H01M 2/1626; H01M 10/446

(57) ABSTRACT

An electrode comprises a manganese oxide compound, one or more additives, and a conductive carbon. The manganese oxide compound has manganese in a valence state that is ≤3. The one or more additives can be selected from the group consisting of bismuth, bismuth salt, copper, copper salt, tin, tin salt, lead, lead salt, silver, silver salt, cobalt, cobalt salt, nickel, nickel salt, magnesium, magnesium salt, aluminum, aluminum salt, potassium, potassium salt, lithium, lithium salt, calcium, calcium salt, gold, gold salt, antimony, antimony salt, iron, iron salt, barium, barium salt, zinc and zinc salt.

### CROSS-REFERENCE TO RELATED APPLICATIONS

This application claims priority to U.S. Provisional Application No. 62/611,947 filed on Dec. 29, 2017 and entitled “Method of Forming Charged Manganese Oxides from Discharged Active Materials”, the entirety of which are incorporated herein by reference.

### STATEMENT OF FEDERALLY SPONSORED RESEARCH OR DEVELOPMENT

This invention was made with Government support under grant number 75906-00 01 awarded by the U.S. Department of Energy. The government has certain rights in the invention.

### BACKGROUND

Manganese oxide-based battery chemistries are used in many applications because of its safety, wide availability and cost favorable characteristics. In these battery chemistries, the manganese dioxide (MnO₂) used is in its charged state (Mn valence ≥4), i.e. it can be used to discharge its capacity/energy immediately. This use is beneficial in primary (one-time use) batteries, where the battery is disposed of when the complete charge of the MnO₂ is used (discharged state, Mn valence ≤3). However, in secondary batteries, where rechargeability is an important requirement, the use of charged active materials like MnO₂ can lead to the formation of inactive materials, which can often lead to battery failure.

### SUMMARY

The following presents a simplified summary of the innovation in order to provide a basic understanding of some aspects of the systems and methods described herein. This summary is not an extensive overview. It is intended to neither identify key or critical elements of the systems and/or methods nor delineate the scope of the systems and/or methods. Its sole purpose is to present some concepts in a simplified form as a prelude to the more detailed description that is presented later.

In some embodiments, an electrode comprises a manganese oxide compound, one or more additives, and a conductive carbon. The manganese oxide compound has manganese in a valence state that is ≤3. The one or more additives can be selected from the group consisting of bismuth, bismuth salt, copper, copper salt, tin, tin salt, lead, lead salt, silver, silver salt, cobalt, cobalt salt, nickel, nickel salt, magnesium, magnesium salt, aluminum, aluminum salt, potassium, potassium salt, lithium, lithium salt, calcium, calcium salt, gold, gold salt, antimony, antimony salt, iron, iron salt, barium, barium salt, zinc and zinc salt.

In some embodiments, a method of forming a battery comprises disposing a cathode within a housing, disposing an anode in the housing, and disposing an electrolyte in the housing. The cathode comprises a manganese oxide compound such that the manganese oxide compound has manganese in a valence state that is ≤3, a binder, and a conductive carbon. The cathode and the anode are separated by a separator within the housing.

In some embodiments, a method for charging a battery comprises charging a battery, and increasing a capacity of the battery from an initial capacity to a final capacity. The battery comprises the initial capacity, and the batter comprises a manganese oxide cathode having manganese in a valence state that is ≤3, a counter-electrode, a reference electrode, a separator, and an electrolyte. The initial capacity is less than the final capacity, and the final capacity is at least 600 mAh/g-MnO.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a cross section view of a battery according to an embodiment.

FIG. 2 is a cross section view of the positive electrode or cathode of the battery according to an embodiment.

FIG. 3 is a cross section view of a battery according to another embodiment.

FIG. 4 is a cross section view of the positive electrode or cathode of the battery according to another embodiment.

FIG. 5 illustrates cycling curves showing potential (vs Hg|HgO) vs time for a MnO electrode.

FIG. 6 illustrates discharge curves for the first 6 cycles of the cathode as described in Example 1.

FIG. 7 illustrates charging curves for the first 6 cycles of the cathode as described in Example 1.

FIG. 8 illustrates the cycling of a 85 wt. % cathode against Zn with a bismuth oxide layer covering the cathode as described in Example 2.

FIG. 9 illustrates the capacity (Ah) vs Cycle for the bismuth oxide layer cell as described in Example 2.

FIG. 10 illustrates the energy efficiency vs Cycle Number for the bismuth oxide layer cell as described in Example 2.

### DETAILED DESCRIPTION

In this disclosure, the terms “negative electrode” and “anode” are both used to mean “negative electrode.” Likewise, the terms “positive electrode” and “cathode” are both used to mean “positive electrode.” Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused. As used herein, the term manganese oxide(s) can refer to any oxide or salt of manganese having a valence state between 2 and 4.

As noted above, the use of charged active materials like MnO₂ can lead to the formation of inactive materials, which can often lead to battery failure. When paired with zinc anodes in alkaline, acidic, organic or ionic liquid-based chemistries, the zinc used is often in its discharged form of ZnO because of the high reversibility associated with the ZnO structure and the ease of manufacturability. Due to the dissimilar state of charge of the MnO₂ (e.g., charged) and ZnO (e.g., discharged) an external step is required to change the state of charge of either electrode(s) against a counter electrode and then finally pair the electrodes to form either a charged MnO₂/Zn system or a discharged MnₓO_{y} (e.g., having Mn valence ≤3)/ZnO system. However, due to the high reversibility associated with anodes starting from ZnO, it would be beneficial to find active materials that are in the discharged form of Mn oxides. As disclosed herein, the use of such discharged Mn active materials are described that show reversibility and capacity >760 mAh/g, which would lead to high energy dense Mn—Zn batteries. In current systems, starting with manganese oxide in a discharged state often does not result in a reversible system, and when it is reversible, it is not stable for long periods of time into the second electron state (e.g., having Mn valence <3).

Disclosed herein are electrodes formed having a manganese oxide compound such that the manganese of the manganese oxide has an average valence state that is ≤3. The electrode can comprise one or more additives and/or a conductive carbon. The one or more additives can be used to improve the long term stability of the electrode and the performance of the electrode. The one or more additives can include, but are not limited to, bismuth, bismuth salt, copper, copper salt, tin, tin salt, lead, lead salt, silver, silver salt, cobalt, cobalt salt, nickel, nickel salt, magnesium, magnesium salt, aluminum, aluminum salt, potassium, potassium salt, lithium, lithium salt, calcium, calcium salt, gold, gold salt, antimony, antimony salt, iron, iron salt, barium, barium salt, zinc and zinc salt, or any combination thereof. The one or more additives can be present in a mixture used to form the electrode or the one or more additives can be present as a separate layer or coating on the manganese oxide layer. A cell comprising the electrode described herein is also disclosed.

When a cell is formed that includes a cathode and an anode having similar states (e.g., both fully or partially charged or discharged, etc.), a charging system as described herein can be used to form a final cell for use. The charging system can include a manganese oxide electrode, a counter-electrode, a reference electrode, a polymeric separator, and an electrolyte. A charging or conditioning protocol as described herein can be used form a final cell containing a manganese oxide electrode that can be used as a primary or secondary battery.

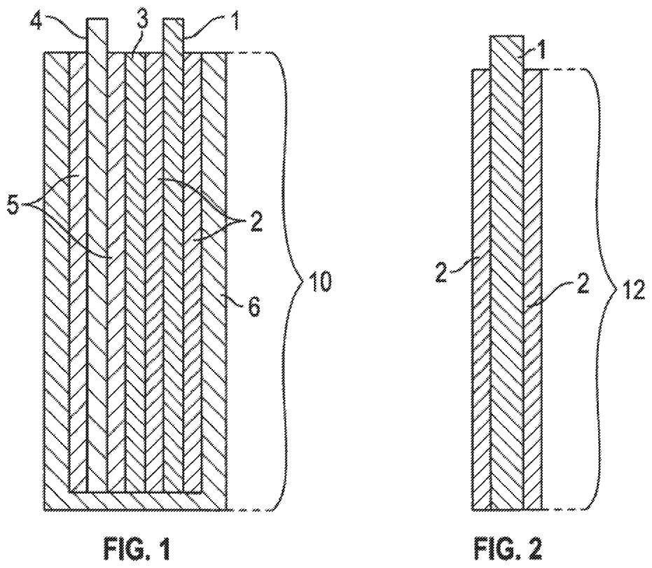

Referring to FIG. 1 a battery 10 has a housing 6, a cathode current collector 1, a cathode material 2, a separator 3, an anode current collector 4, and an anode material 5. FIG. 1 shows a prismatic battery arrangement having one anode and one cathode. In another embodiment, the battery can have a cylindrical configuration. Further, the battery 10 can comprise any number of anodes and cathodes arranged in an alternating configuration to create the cell. In some embodiments, the electrodes can have a rolled configuration such that a cross section through the battery has an alternating anode/cathode layering when one or more of each electrode are present. An electrolyte can be dispersed between the electrodes (including within the porosity of the electrodes themselves) throughout battery 10. Referring to FIG. 2 the cathode current collector 1 and cathode material 2 are collectively called either the cathode 12 or the positive electrode 12. Similarly, the anode current collector 4 and the anode material 5 can be collectively called either the anode or the negative electrode.

The art described in this disclosure is with regards to the development of rechargeable alkaline cells that employ a cathode material 2 that uses a manganese oxide having an at least partially discharged state. In some embodiments, the manganese oxide used to form the call can comprise a manganese oxide having a valence state that is ≤3. Suitable manganese oxides can comprise MnO, Mn₃O₄, Mn₂O₃, MnOOH, Mn(OH)₂, XMn₂O₄ (where X=Li, Zn, Cu, Al, H) including α, β, γ, λ, ∈, δ polymorphs, or any combination thereof. In some embodiments, the manganese in the manganese oxide can have a valence state that is less than 3, for example, a valence stated between 2 and 3, or a valence state of 2.

In general the cycled form of manganese dioxide in the cathode can be δ-MnO₂ which is interchangeably referred to as birnessite. When the non-birnessite polymorphic forms of manganese oxide are initially used in the cells as described herein, these forms can be converted to birnessite in-situ by one or more conditioning cycles. For example, a full discharge to the end of the MnO₂ second electron stage may be performed and subsequently recharging back to its Mn⁴⁺ state, resulting in birnessite-phase manganese dioxide. In some embodiments, the manganese oxide used to form the cathode can have a valence state of about 2, and one or more cycling steps can be used to condition and form the birnessite-phase manganese dioxide within the cell, for example, by charging the cathode within the cell or against a separate anode prior to completing the cell for use as a battery.

The cathode material 2 can comprise additional components as a mixture, and the mixture can then be formed into a layer of the cathode material 2 that is used to form the cathode 12. In some embodiments, the cathode material 2 can comprise the manganese oxide having a valence state that is ≤3 along with some additional components, and a separate layer of additional material(s) can be used to coat the cathode material or be formed as a separate layer that is placed into contact with the cathode material layer during construction. The additives and materials are described first, and the structure of the cathode material and resulting cathode are described thereafter.

The cathode 12 can comprise one or more additives such as bismuth and/or copper. In some embodiments, the cathode material can include a bismuth compound and/or a copper compound, which together can allow galvanostatic battery cycling of the cathode. The bismuth compound can be incorporated into the cathode 12 as an inorganic or organic salt of bismuth (e.g., in oxidation states 5, 4, 3, 2, and/or 1), as a bismuth oxide, or as bismuth metal (i.e., elemental bismuth). The bismuth compound can be present in the cathode material at a concentration between 1-20 wt %. Examples of suitable bismuth compounds include bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, triphenylbismuth, or any combination thereof.

The copper compound can be incorporated into the cathode material as an organic or inorganic salt of copper (e.g., in oxidation states 1, 2, 3, and/or 4), as a copper oxide, and/or as copper metal (i.e., elemental copper). The copper compound can be present in a concentration between 1-70 wt %, between 5-50 wt %, between 10-50 wt %, or alternatively between 5-20 wt %. Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc. The effect of copper is to alter the oxidation and reduction voltages of bismuth. This results in a cathode with full reversibility during galvanostatic cycling, as compared to a bismuth-modified MnO₂ which will not withstand galvanostatic cycling. In some embodiments, the copper can be present in the form of elemental copper such as a coating on the current collector and/or as a solid current collector formed from copper or an allow of copper (e.g., brass, etc.).

In some embodiments, the cathode can comprise a conductive carbon. The addition of the conductive carbon enables high loadings of manganese oxide(s) in the cathode material, resulting in high volumetric and gravimetric energy density. The conductive carbon can be present in a concentration between about 2-30 wt %. Such conductive carbon can include single walled carbon nanotubes, multiwalled carbon nanotubes, graphene, carbon blacks of various surface areas, and others that have specifically very high surface area and conductivity. Higher loadings of the manganese oxide(s) in the mixed material electrode are, in some embodiments, desirable to increase the energy density. Other examples of conductive carbon include TIMREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), graphene, graphyne, graphene oxide, Zenyatta graphite, carbon nanotubes plated with copper, nickel, and/or silver, or any combination thereof. When present, a conductive carbon can be further protected with a deposit of nickel, copper, tin, aluminum, cobalt, silver or nickel-phosphorous. The deposit may be applied by chemical vapor deposition or physical vapor deposition. Electrochemical methods with a power source or electroless deposition methods can be used as well. In some embodiments, nanowires of copper, nickel and/or silver can be used in addition to or in place of the conductive carbon as a conductive agent.

In some embodiments, the cathode can comprise a supporting material in addition to or in place of the conductive carbon. The supporting materials can comprise calcium hydroxide, magnesium hydroxide, nickel hydroxide, titanium dioxide or cobalt oxide. The supporting materials can serve to improve the cycling performance of the cathode during use, including the ability to reduce the formation of insoluble compounds.

In some embodiments, the cathode can comprise a conductive metal additive. The addition of conductive metal additive(s) to the cathode may be accomplished by addition of a powder of flakes to the cathode mixture. For example, nickel powder can be added to a mixture of a manganese oxide with bismuth and/or copper. When present, the conductive metal additive can be present in a concentration of great than 0% up to about 30 wt %. The conductive metal additive may be, for example, nickel, copper, silver, gold, tin, cobalt, antimony, brass, bronze, aluminum, calcium, iron, and/or platinum. In some embodiments, the conductive metal additive can be a powder, shavings, flakes, or the like. In some embodiments, a second conductive metal additive can be added to act as a supportive conductive backbone for the first and second electron reactions to take place. The second electron reaction has a dissolution-precipitation reaction where Mn³⁺ ions become soluble in the electrolyte and precipitate out on the graphite resulting in an electrochemical reaction and the formation of manganese hydroxide [Mn(OH)₂] which is non-conductive. This can ultimately result in a capacity fade in subsequent cycles. Suitable second additives can include transition metals like Ni, Co, Fe, Ti, and metals like Ag, Au, Al, Ca. Salts of such metals can also be used. Transition metals like Co also help in reducing the solubility of Mn³⁺ ions. Such conductive metal additives may be incorporated into the electrode by chemical means or by physical means (e.g., ball milling, mortar/pestle, spex mixture).

In some embodiments a binder can be used in the cathode. The binder can be present in a concentration of between about 0-10 wt %. In some embodiments, the binder can comprise water-soluble cellulose-based hydrogels, which can be used as thickeners and strong binders, and can be cross-linked with good mechanical strength and with conductive polymers. In some embodiments, the binder may also be a cellulose film sold as cellophane. The binders can be made by physically cross-linking water-soluble cellulose-based hydrogels with a polymer through repeated cooling and thawing cycles. In some embodiments, between about 0-10 wt. % carboxymethyl cellulose (CMC) solution can be cross-linked with between about 0-10 wt. % polyvinyl alcohol (PVA) on an equal volume basis. The binder, compared to the traditionally-used TEFLON®, shows superior performance. TEFLON® is a resistive material, but its use in the industry has been widespread due to its good rollable properties. This, however, does not rule out using TEFLON® as a binder. Mixtures of TEFLON® with the aqueous binder and some conductive carbon can be used to create rollable binders. Using the aqueous-based binder helps in achieving a significant fraction of the two electron capacity with minimal capacity loss over a large number of cycles (e.g., greater than 300 cycles, 400 cycles, etc.). In some embodiments, the binder can be water-based, have superior water retention capabilities and adhesion properties, and help to maintain the conductivity relative to identical cathode using a TEFLON® binder instead. Examples of suitable hydrogels can include, but are not limited to, methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC). Examples of crosslinking polymers can include, but are not limited to, polyvinyl alcohol, polyvinylacetate, polyaniline, polyvinylpyrrolidone, polyvinylidene fluoride and polypyrrole. In some embodiments, a 0-10 wt % solution of water-cased cellulose hydrogen can be cross linked with a 0-10% wt solution of crosslinking polymers by, for example, repeated freeze/thaw cycles, radiation treatment or chemical agents (e.g. epichlorohydrin). In some embodiments, the aqueous binder may be mixed with 0-5% TEFLON® to improve manufacturability.

In some embodiments, the cathode material comprises 2-30% wt conductive carbon, 0-30% conductive metal additive, 1-70% wt. copper compound, 1-20% wt bismuth compound, 0-10% wt binder and the balance being a manganese oxide. In some embodiments, the cathode can comprise 2-30% wt conductive carbon, 0-30% conductive metal additive, 1-20% wt bismuth compound, 0-10% wt binder and the balance being a manganese oxide. In some embodiments, the cathode consists essentially of 2-30% wt conductive carbon, 0-30% conductive metal additive, 1-70% wt. copper compound, 1-20% wt bismuth compound, 0-10% wt binder and the balance being a manganese oxide (e.g., a manganese oxide having the manganese with a valence state of equal to or less than 3).

In some embodiment, the compositions noted above can be used to form a cathode mixture, which can be formed into a layer (e.g., by rolling, etc.) and pressed onto a current collector as described in more detail herein. The cathode mixture can be mixed so that the components are relatively uniform within the cathode mixture.

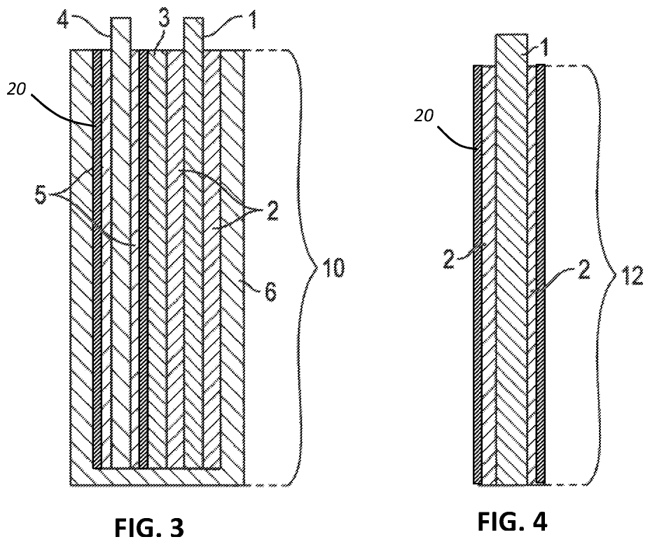

In some embodiments, the energy density of the cathode can be improved by providing a high weight loading of the manganese oxides in an active material layer. As shown in FIGS. 3 and 4, for example, the cathode 12 can comprise an active material layer 2 having a manganese oxide loading of greater than 70 wt. %, greater than 75 wt. %, greater than 80 wt. %, or greater than 85 wt. % loading of the cathode mixture layer. The balance of this layer can include a binder and/or a conductive additive such as a conductive carbon as described herein. The other additives can then be placed in a separate additives layer 20 and/or coated on the cathode active material layer 2.

In some embodiments, an additives layer 20 can comprise a binder, a bismuth compound, a copper compound, and one or more conductive metal additives. The combination of the active material layer and the additives layer can have the weight loadings as described herein. For example, the combination of the active material layer 2 and the additives layer 20 can comprises 2-30% wt conductive carbon, 0-30% conductive metal additive, 1-70% wt. copper compound, 1-20% wt bismuth compound, 0-10% wt binder and the balance being a manganese oxide. The manganese oxide and optionally at least a portion or all of the conductive carbon and at least a portion of all of the binder can be present in the active material layer, and the conductive metal additives, bismuth compounds, and/or copper compounds can be present in the additives layer with optionally a portion of the binder and potentially a portion of the conductive carbon. When separated, the active material layer 2 can be in contact with the current collector 1, and the additives layer 20 can be coated on or disposed in contact with the active materials layer 2 on a side opposite the side of the active materials layer 2 in contact with the current collector 1. By separating the materials into layers, the weight loading of the active material can be increased while still obtain the benefits of the additives within the cathode.

Whether present in one or more layers, the cathode material can be disposed in contact with a current collector. The cathode material can be adhered to the cathode current collector 1 by pressing at, for example, a pressure between 1,000 psi and 20,000 psi. The cathode material 2 may be adhered to the cathode current collector 1 as a paste and/or as a pre-dried sheet. A tab of each current collector extends outside of the device to provide for an electrical connection to the cathode current collector 1. In some embodiments, the tab may cover less than 0.2% of the electrode area.

The cathode current collector 1 may be a conductive material to serve as an electrical connection between the cathode material 2 and the external electrical connections. In some embodiments, the cathode current collector 1 can be, for example, nickel, steel, nickel-coated steel, tin-coated steel, silver coated copper, copper plated nickel, nickel plated copper, copper, magnesium, aluminum, tin, iron or a mesh with half nickel and half copper, or similar material. In some embodiments, the copper compound present in the cathode can be present on or as part of the current collector. For example, a copper current collector, a copper coated current collector, or a current collector comprising a copper alloy can be used to introduce copper into the cathode. The cathode current collector 1 may be formed into an expanded mesh, perforated metal, foam, foil, perforated foil, wire screen, or a wrapped assembly. In some embodiments, the current collector can be formed into or form a part of a pocket assembly where the active material is enclosed within a porous or otherwise permeable current collector pocket or envelope.

The cathodes 12 can be produced using methods implementable in large-scale manufacturing. In some embodiments, the cathode material 2 that can be present in one or more layers can be adhered to the cathode current collector 1 by pressing at, for example, a pressure between 1,000 psi and 20,000 psi (between 6.9×10⁶ and 1.4×10⁸ Pascals). The cathode material 2 may be adhered to the cathode current collector 1 as a paste.

The cathode 12 can be capable of delivering the full second electron capacity of approximately 770 mAh/g of the manganese oxides (e.g., MnO). The resulting cathode may have a porosity in the range of 20%-85% as determined by mercury infiltration porosimetry. In one embodiment, the porosity is measured according to ASTM D4284-12 “Standard Test Method for Determining Pore Volume Distribution of Catalysts and Catalyst Carriers by Mercury Intrusion Porosimetry.

The separator 3 clearly demarcates the cathode 12 from the negative electrode. The separator 3 may be a polymeric separator (e.g. cellophone, sintered polymer film, or a hydrophilically modified polyolefin). As used in this specification, the phrase “hydrophilically modified polyolefin” refers to a polyolefin whose contact angle with water is less than 45°. In another embodiment, the contact angle with water is less than 30°. In yet another embodiment, the contact angle with water is less than 20°. The polyolefin may be modified by, for example, the addition of TRITON X-100™ or oxygen plasma treatment. The battery 10 was demonstrated to provide high depth of discharge of about 617 mAh/g-MnO₂ for many more cycles than achievable with a simpler MnO₂+Bi cathode material containing no Cu.

As described herein, the anode can comprise zinc, though other materials can also be used. In some embodiments, the anode material 5 comprises zinc, which can be present as elemental zinc or zine oxide. In some embodiments, the Zn anode mixture comprises Zn, zinc oxide (ZnO), an electronically conductive material, and a binder. The Zn may be present in the anode material 5 in an amount of from about 50 wt. % to about 90 wt. %, alternatively from about 60 wt. % to about 80 wt. %, or alternatively from about 65 wt. % to about 75 wt. %, based on the total weight of the anode material 5. In an embodiment, Zn may be present in an amount of about 85 wt. %, based on the total weight of the anode material 5. As will be appreciated by one of skill in the art, and with the help of this disclosure, the purpose of the ZnO in the non-flow cell Zn anode mixture is to provide a source of Zn during the recharging steps, and the zinc present in either form can be converted during charging and discharging phases. Depending on the desired starting materials and state of charge, the anode may comprise substantially all ZnO or Zn.

In an embodiment, an electronically conductive material may be present in the anode material 5 in an amount of from about 5 wt. % to about 20 wt. %, alternatively from about 5 wt. % to about 15 wt. %, or alternatively from about 5 wt. % to about 10 wt. %, based on the total weight of the anode material 5. In an embodiment, the electronically conductive material may be present in anode material 5 in an amount of about 10 wt. %, based on the total weight of the anode material 5. As will be appreciated by one of skill in the art, and with the help of this disclosure, the electronically conductive material is used in the non-flow cell Zn anode mixture as a conducting agent, e.g., to enhance the overall electronic conductivity of the non-flow cell Zn anode mixture. Non-limiting examples of electronically conductive material suitable for use in in this disclosure include any of the carbon based conductive agents described with respect to the cathode, including, but not limited to, carbon, graphite, graphite powder, graphite powder flakes, graphite powder spheroids, carbon black, activated carbon, conductive carbon, amorphous carbon, glassy carbon, and the like, or combinations thereof.

The anode material 5 may also comprise a binder. In an embodiment, the binder can comprise any of the binders used with the cathode material 2 as described herein. Generally, a binder functions to hold the electroactive material particles (e.g., Zn, ZnO, etc.) together and in contact with the current collector. In an embodiment, the binder may be present in anode material 5 in an amount of from about 2 wt. % to about 10 wt. %, alternatively from about 2 wt. % to about 7 wt. %, or alternatively from about 4 wt. % to about 6 wt. %, based on the total weight of the anode material 5. In an embodiment, the binder may be present in anode material 5 in an amount of about 5 wt. %, based on the total weight of the anode material 5.

In an embodiment, the binder may comprise a polymer; a fluoropolymer, polytetrafluoroethylene (PTFE), a copolymer of tetrafluoroethylene and propylene; polyvinylidene fluoride (PVDF), a copolymer of styrene and butadiene, styrene-butadiene rubber (SBR); a conducting polymer, polyaniline, polypyrrole, poly(3,4-ethylenedioxylthiophene) (PEDOT), copolymers of 3,4-ethylenedioxylthiophene with various co-monomers (e.g., PEDOT with various dopants), a copolymer of 3,4-ethylenedioxylthiophene and styrenesulfonate (PEDOT:PSS), polyvinyl alcohol (PVA), hydroxymethyl cellulose (HMC), carboxymethyl cellulose (CMC), and the like, or combinations thereof. In an embodiment, the binder used in a anode material 5 can comprise TEFLON, which is a PTFE commercially available from DuPont.

The anode material 5 can be coupled to the anode current collector 4, where the anode current collector 4 can include any of the current collectors described with respect to the cathode current collector 1. In some embodiments, the current collector comprises a porous metal collector further comprising a variety of collector configurations, such as for example a metal conductive mesh, a metal conductive interwoven mesh, a metal conductive expanded mesh, a metal conductive screen, a metal conductive plate, a metal conductive foil, a metal conductive perforated plate, a metal conductive perforated foil, a metal conductive perforated sheet, a sintered porous metal conductive sheet, a sintered metal conductive foam, an expanded conductive metal, a perforated conductive metal, and the like, or combinations thereof. Other porous collector configurations of the current collector will be appreciated by one of skill in the art in light of this disclosure. In some embodiments, the current collector can comprise a metal collector pocketed assembly.

In some embodiments, the anode current collector 4 may further comprise a current collector tab. In such embodiments, the current collector tab may comprise a metal, nickel, copper, steel, and the like, or combinations thereof. Generally, the current collector tab provides a means of connecting the electrode to the electrical circuit of the battery. In some embodiments, the current collector tab is in electrical contact with an outer surface of the electrode. In some embodiments, the current collector tab is in electrical contact with less than about 0.2% of an outer surface of the electrode, alternatively less than about 0.5%, or alternatively less than about 1%.

In some embodiments, the anode material 5 may be pressed onto the anode current collector 4 to yield the anode. In some embodiments, the anode material 5 may be in the form of a dried sheet or a paste that can be pressed onto the current collector under high pressure, such as for example a pressure of from about 3,000 psi to about 10,000 psi, alternatively about 5,000 psi to about 9,000 psi, or alternatively about 6,000 psi to about 8,000 psi. In some embodiments, the anode material 5 may be pressed onto the anode current collector 4 such that the anode material 5 is in electrical contact with at least a portion of an outer surface of the anode current collector 4.

While described as being used with zinc, other suitable anode materials can also be used in an appropriate charged or discharged form. In some embodiments, the anode can comprise nickel oxyhydroxide (NiOOH), iron, cadmium and metal hydride (MH).

The separator 3 forms an electrically insulating barrier between the anode and the cathode while being porous to allow for ionic flow in the electrolyte between the electrodes. By being placed between the electrodes, the separator 3 serves to prevent shorting that could occur due to direct electrical contact between the electrodes. As will be appreciated by one of skill in the art, the separator 3 allows the electrolyte, or at least a portion and/or component thereof, to pass (e.g., cross, traverse, diffuse, etc.) through the electrode separator membrane, to balance ionic flow and sustain the flow of electrons in the battery. In this regard, the separator 3 serves to demarcates the cathode from the anode.

The separator 3 can comprise one or more layers. Suitable layers can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified polyolefin” refers to a polyolefin whose contact angle with water is less than 45°. In another embodiment, the contact angle with water is less than 30°. In yet another embodiment, the contact angle with water is less than 20°. The polyolefin may be modified by, for example, the addition of TRITON X-100™ or oxygen plasma treatment. In some embodiments, the separator 3 can comprise a CELGARD® brand microporous separator. In an embodiment, the separator 3 can comprise a FS 2192 SG membrane, which is a polyolefin nonwoven membrane commercially available from Freudenberg, Germany.

When assembled into a cell, the cell 10 can comprise an electrolyte that serves as an ion transporter such as an aqueous battery electrolyte or an aqueous electrolyte. In an embodiment, the electrolyte can comprises any suitable aqueous electrolyte comprising ionic conductivity and with a pH value between 1 and 14. In an embodiment, the electrolyte has a pH value of about 14, alternatively less than about 14, alternatively less than about 13, or alternatively less than about 12. In the case of rechargeable batteries, the electrolyte is important both for the active/discharging cycle of the battery (while the battery supplies a current) and for the recharging cycle when Zn may be electrodeposited to replenish the anode material.

In some embodiments, the electrolyte comprises a hydroxide such as potassium hydroxide, sodium hydroxide, lithium hydroxide, and the like, or combinations thereof, in a concentration of from about 1 wt. % to about 50 wt. %, alternatively from about 10 wt. % to about 40 wt. %, or alternatively from about 25 wt. % to about 35 wt. %, based on the total weight of the non-flow cell electrolyte solution. In some embodiments, the electrolyte comprises potassium hydroxide in a concentration of about 30 wt. %, based on the total weight of the electrolyte within the cell 10.

In some embodiments, the disclosed battery delivers high energy density (e.g. greater than 50 Wh/L), at a high depth of discharge (e.g. greater than 50% of the second electron capacity, i.e. greater than 318 mAh/g-MnO₂) and high C-rates (e.g. greater than 1 C). In one embodiment, the depth of discharge is greater than 90% of the second electron capacity after ten cycles.

In some embodiments, the cell 10 may be assembled by using any suitable methodology. In an embodiment, the cell 10 may comprise at least one anode and at least one cathode. In an embodiment, the cell 10 may comprise more than one anode and more than one cathode, wherein the anodes and the cathodes are assembled in an alternating configuration, e.g., the anodes and the cathodes are sandwiched together in an alternating manner. For example, if a cell 10 comprises two cathodes and three anodes, the electrodes would be sandwiched together in an alternating manner: anode, cathode, anode, cathode, and anode. In some embodiments, the cell 10 can be constructed with one or more anodes and one or more cathodes having a rolled configuration. For example, an anode and cathode can be layered and then rolled to create a rolled structure with a cross-section comprising an anode, cathode, anode, cathode, etc. in an alternating configuration. As will be appreciated by one of skill in the art, and with the help of this disclosure, the number of electrodes in a cell 10 is dependent upon the desired parameters for such cell 10, including consideration such as the size and properties of the electrodes, such that anode and the cathode capacities may be at least approximately balanced.

Once assembled, the cells can be conditioned to form the final battery (e.g., a primary cell, a secondary cell, etc.). As described herein, the battery can be operated by being discharged and then recharged to serve as a secondary battery. In some embodiments, the battery can operate as a primary battery and be discharged prior to be discarded. During the charging and discharging cycles, which can occur a plurality of times, the bismuth and copper intercalated birnessite can be used to stabilize the cathode when used with Li-ion, Mg-ion, Zn-ion and Al-ion batteries, thus allowing for repeated cycling without substantial degradation. This allows for a long-life battery to be formed using the materials and battery chemistries as described herein.

In some embodiments, the battery comprising the stabilized Cu—Bi-birnessite cathode can have a capacity of at least 100 mAh/g, or at least 150 mAh/g, at least 200 mAh/g, or at least 250 mAh/g for at least 100 cycles, at least 200 cycles, at least 300 cycles, at least 400 cycles, or at least 500 cycles. In some embodiments, the battery comprising the stabilized Cu—Bi-birnessite cathode can have a capacity of at least 100 mAh/g or at least 150 mAh/g for at least 500 cycles, at least 100 cycles, or at least 1500 cycles. In some embodiments, the battery comprising the stabilized Cu—Bi-birnessite cathode can retain at least about 50%, at least about 60%, or at least about 70% of the initial capacity for at least about 100 cycles, at least 200 cycles, at least 300 cycles, at least 400 cycles, or at least 500 cycles.

When the cell as assembled comprises an electrode in a discharged state and/or electrodes that are in different states of charge, an initial conditioning step can be carried out to prepare the cell for use as a battery. Such a conditioning step may be used when the manganese oxide used in the cathode has a valence state less than or equal to 3.

In some embodiments, one or more electrodes used in (or to be used in) the cell can be cycled using a charging system. The charging system can comprise the cathode as described herein, a counter-electrode, and a reference electrode, along with a separator and electrolyte. The separator and electrolyte can comprise any of those described herein. A charging protocol can then be used to cycle the electrodes. For example, the cathode and/or anode can be cycled to produce the final cell to be used as a battery.

The counter electrode can be the anode as constructed in the cell, but does not necessarily have to be the same. In some embodiments, the cathode can be charged or cycled independent of the cell, for example, as an initial conditioning step prior to constructing the cell. Alternatively, a different anode can be used to prepare the cathode in situ. In some embodiments, the counter-electrode for the conditioning process can comprise zinc, zinc oxide, aluminum, aluminum oxide, lithium, magnesium, iron, iron hydroxide, nickel, nickel hydroxide, tin, tin oxide, bismuth, bismuth oxide, potassium, selenium, cobalt, cobalt oxide, titanium, titanium oxide or combinations thereof.

The reference electrode can be used to provide a consistent charging protocol between cells so that the voltage references may not depend on the specific composition of the anode. The reference electrode can generally be present within the cell or otherwise in electrical contact with the electrolyte in order to determine the potential of the cell during the charging protocol. In some embodiments, the reference electrode can be a mercury(Hg)|Mercury oxide(HgO) reference electrode, a standard hydrogen electrode reference electrode, a mercury|mercury chloride reference electrode, or a silver|silver chloride reference electrode. While references to the mercury(Hg)|Mercury oxide(HgO) reference electrode are provided herein, the reference potentials can be converted to other reference electrodes using known conversion values.

A number of charging protocols can be used to condition the cathode, the anode, or both. In some embodiments, the charging protocol can comprise a step of increasing the state of charge of the manganese oxide to at least 95%, at least 98%, or at least 99%. In this process, the valence state of the manganese oxide can increase from less than or equal to 3 to at least 4 or greater than 4. In order to increase the state of charge, the cathode can be charged to between about greater than or equal 0.2 V and less than or equal to 1 V vs a Hg|HgO reference (e.g., ≥1.5V and ≤2.5V vs a Zn reference).

During the charging process, the structure of the manganese oxide will change, and through repeated cycling the cathode can develop charged MnO2 in a reversible form (e.g., birnessite incorporating bismuth and copper into the crystal structure such as bismuth and copper intercalated birnessite). In order to fully develop the reversibility and capacity of the cathode, the cathode can be discharged and recharged as part of the charging protocol. Once charged as noted above, the cathode can be discharged to at least −1V vs a Hg|HgO reference (e.g., 0.3V vs a Zn reference). The resulting charging and discharging cycles can be repeated until the capacity of the cathode increases to at least about 600 mAh/g-MnO (milliamp hours per gram of MnO), at least about 650 mAh/g-MnO, at least about 700 mAh/g-MnO, at least about 750 mAh/g-MnO, or at least about 770 mAh/g-MnO. The charging protocol may comprise between 2 and 10 charge and discharge cycles. For example, the charging protocol may comprise at least 2 charging cycles with a discharging cycle between, at least about 3 charging cycles with two discharging cycles between, etc. Once the final capacity has been achieved, the cell can be ready for use. If the cathode is charged outside of the final cell, the final cell can be constructed with the charged cathode for use as a battery (e.g., a primary cell or a secondary cell).

Within the charging protocol, the charging steps can comprise constant current or constant voltage steps. Further, the charge density can be varied between steps. In some embodiments, each successive charging step can be carried out at a lower C-rate (e.g., a lower current density), until a final charged cathode is obtained. For example, a charge protocol can comprise cycling the cell between about ≥0.2V and ≤1V vs a Hg|HgO reference with an intermediate discharge to −1V vs a Hg|HgO reference, where each successive charge step is carried out a lower current density. In some embodiments, the current density can be decreased by a factor of at least about 1.5, at least about 1.75, or at least about 2.0 between each successive charging step. This can be accomplished by using a constant current charging step having a reduced constant current in each successive charging step. The cathode can be set to an open circuit voltage to discharge the cell between each charging step in order to reduce the cathode voltage to the desired level.

The resulting charging protocol can then result in a cathode having the capacity as described herein when starting with a discharged form of manganese oxide, for example where the valence state of the manganese is less than or equal to 3, and in some embodiments the valence state can be equal to or less than 2. This can result in a reversibly chargeable cathode having manganese oxide that can cycle into its second electron capacity.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

Example 1: An electrode mix comprising of 40.77 wt. % MnO, 8.15 wt. % Bi₂O₃, 32.6 wt. % CNTs and 18.48 wt. % elemental copper was pasted on a nickel current collector. The electrode was paired against a sintered nickel counter electrode and its potential was controlled against a mercury|mercury oxide (Hg|HgO) reference electrode. 25 wt. % KOH was used as the electrolyte in the cell. The cell was cycled between 0.4V and −1V vs Hg|HgO.

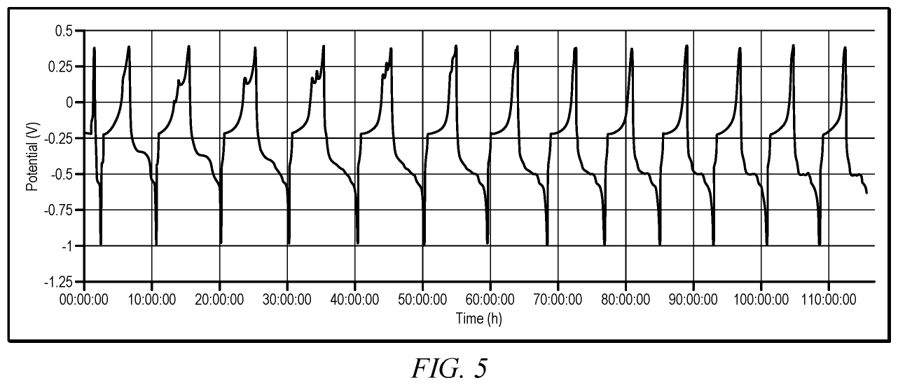

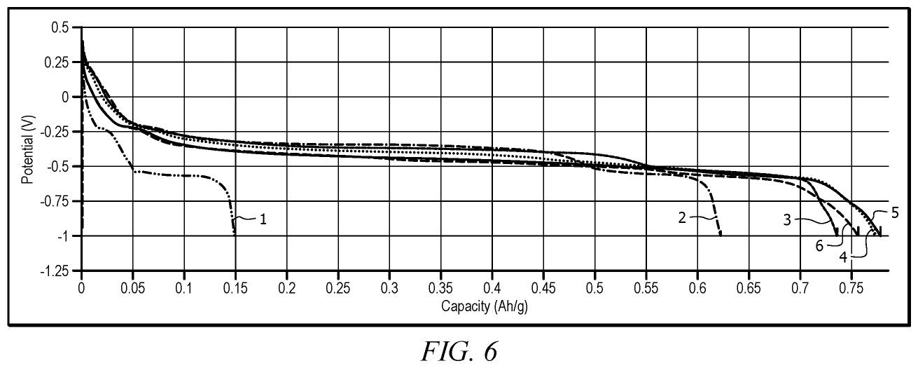

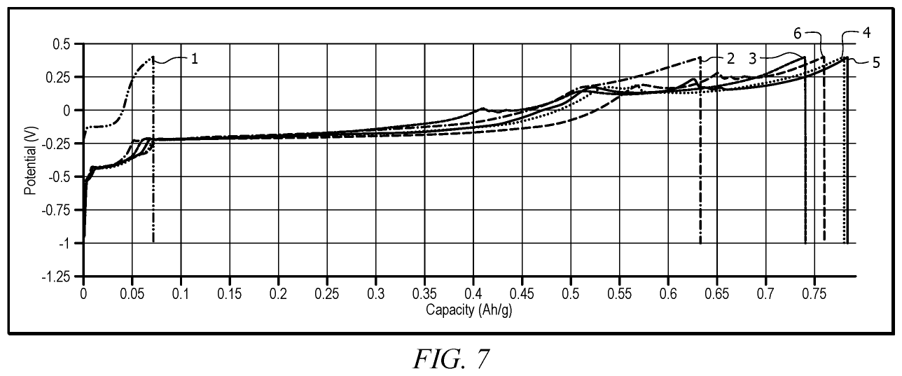

The cycling data of this electrode is shown in FIG. 5, where due to the low oxidation state of Mn the OCV is lower than traditional primary cathodes like MnO₂. Thus, MnO is a good example compound representing a discharged or low state of charge manganese oxide electrode. The electrode is initially charged to 0.4V vs Hg|HgO to increase the state of charge and then discharged to −1V vs Hg|HgO to begin the formation process of making charged MnO₂. Detailed discharge and charge curves are shown in FIGS. 6 and 7, respectively.

FIGS. 6 and 7 show the progressive increase in capacity to ˜770 mAh/g for the charge and discharge cycles. This is the highest capacity reported for a manganese oxide electrode in alkaline batteries. The flat discharge curves seen are representative of a birnessite phase MnO₂. This is the first such demonstration of “forming” a fully charged MnO₂ from its discharged state and with a much higher capacity.

### Example 2

Example 2: To increase the energy density of the electrode increasing the active material loadings of the electrode to >80 wt. % is important. The additives which are normally included in the mix were added over the electrode as an “interlayer” to increase the wt. % loading and thus, energy density. A charged cell was made with 85 wt. % active material manganese oxide loading cathode and a charged zinc anode, where a layer of bismuth oxide was placed over the cathode. The layer comprised of 95 wt. % bismuth oxide and 5 wt. % TEFLON. 25 wt. % KOH was used as the electrolyte. The cell was cycled between 1.75 and 0.3V with modified charge step. The charge step involved successive constant current steps with reducing current density till the capacity was reached. Between each successive steps the cell was set at OCV for 0.5 to 1 hr.

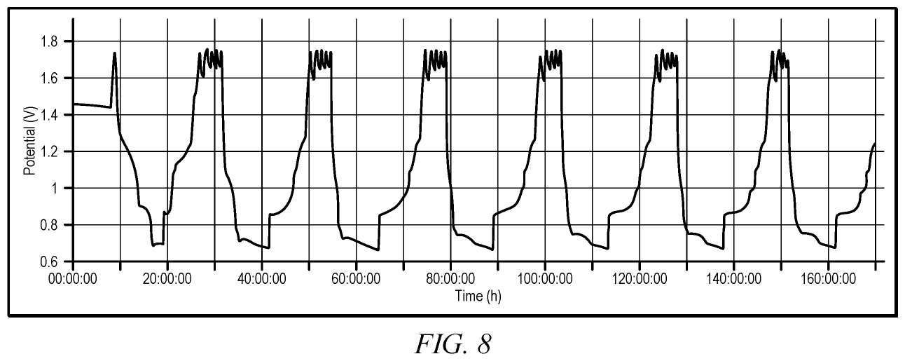

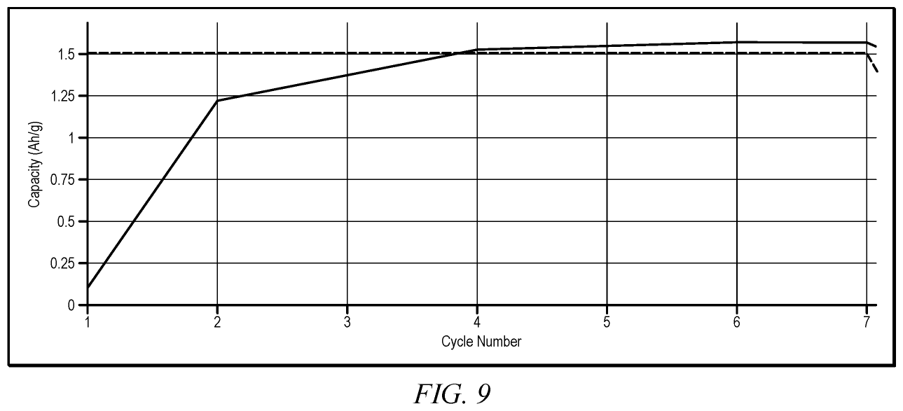

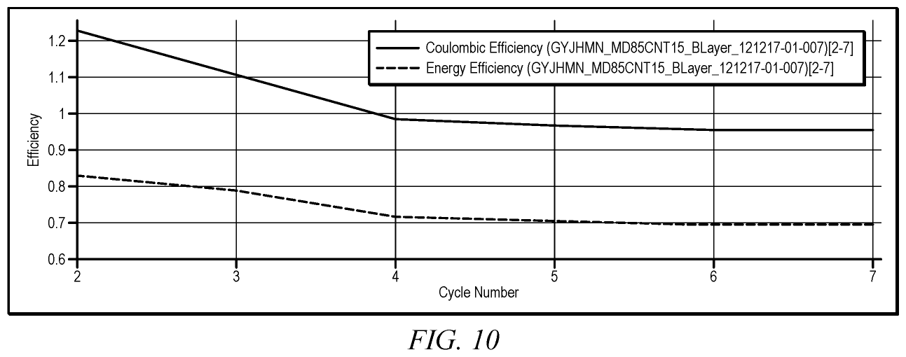

FIG. 8 shows the capacity obtained on charge is usually in 4 constant current steps, while the capacity obtained on discharge is achieved by ˜0.68V, which is 0.38V above the end of discharge limit. This is the first such demonstration of a rechargeable 85 wt. % loading manganese oxide cell with reversibility to its 2^{nd} electron capacity. FIGS. 9 and 10 show the stable capacity and energy efficiency of ˜70-80% of the cell, which is the best for 2^{nd} electron rechargeable manganese oxide cells. The amount of bismuth oxide in the layer can be reduced by replacing its wt. % with supporting materials like calcium hydroxide, nickel hydroxide, magnesium hydroxide, carbon, titanium oxide and cobalt oxide.

The role of copper is to enhance the charge transfer characteristics of manganese dioxide through intercalation mechanisms and/or reduce pore electrolyte resistance.

Having described various systems and methods, specific embodiment can include, but are not limited to:

In a first embodiment, an electrode comprises: a manganese oxide compound, wherein the manganese oxide compound has manganese in a valence state that is ≤3; one or more additives selected from the group consisting of bismuth, bismuth salt, copper, copper salt, tin, tin salt, lead, lead salt, silver, silver salt, cobalt, cobalt salt, nickel, nickel salt, magnesium, magnesium salt, aluminum, aluminum salt, potassium, potassium salt, lithium, lithium salt, calcium, calcium salt, gold, gold salt, antimony, antimony salt, iron, iron salt, barium, barium salt, zinc and zinc salt; and a conductive carbon

A second embodiment can include the electrode of the first embodiment, wherein the manganese oxide compound is selected from MnO, Mn₃O₄, Mn₂O₃, MnOOH, Mn(OH)₂, XMn₂O₄ (where X=Li, Zn, Cu, Al, H) including α, β, γ, λ, ∈, δ polymorphs t, and combinations thereof.

A third embodiment can include the electrode of the first or second embodiment, wherein the one or more additives are in oxide form, hydroxide form, or elemental form.

A fourth embodiment can include the electrode of the third embodiment, wherein the one or more additives are selected from the group consisting of bismuth oxide, bismuth hydroxide, copper oxide, copper hydroxide, cobalt hydroxide, lead oxide, silver oxide, nickel oxide, nickel hydroxide, lithium hydroxide, aluminum hydroxide, barium hydroxide, nickel, copper, bismuth, cobalt.

A fifth embodiment can include the electrode of any one of the first to fourth embodiments, wherein the at least one additive of the one or more additives is in powder form or metallic support form.

A sixth embodiment can include the electrode of the fifth embodiment, wherein the metallic support form is a mesh, a foil, a ingot, or a wire.

A seventh embodiment can include the electrode of any one of the first to sixth embodiments, wherein the one or more additives comprise bismuth oxide, bismuth hydroxide, or elemental bismuth.

An eighth embodiment can include the electrode of any one of the first to seventh embodiments, wherein the one or more additives form an additive layer, wherein the manganese oxide is disposed in an active material layer, and wherein the additive layer is in contact with the active material layer.

A ninth embodiment can include the electrode of the eighth embodiment, wherein the additives layer comprises 1-95 wt. % bismuth oxide, bismuth hydroxide, or bismuth, and 5-99 wt. % of a binder, supporting materials, or both.

A tenth embodiment can include the electrode of the eighth or ninth embodiment, wherein the active material layer comprises supporting materials, and wherein the supporting materials comprise carbon, calcium hydroxide, magnesium hydroxide, nickel hydroxide, titanium dioxide or cobalt oxide.

An eleventh embodiment can include the electrode of any one of the first to tenth embodiments, wherein the conductive carbon comprises graphite, carbon black, acetylene black, single walled carbon nanotubes, multi-walled carbon nanotubes, single and multi-walled carbon nanotubes coated with nickel or copper, graphene, graphyne, graphene oxide, or any combination thereof.

A twelfth embodiment can include the electrode of any one of the first to eleventh embodiments, wherein the electrode consists essentially of greater than 0 wt. % and less than or equal to 99 wt. % of the manganese oxide compound; greater than 0 wt. % and less than or equal to 99 wt. % the conductive carbon; and the balance being the one or more additive.

A thirteenth embodiment can include the electrode of any one of the first to twelfth embodiments, wherein the electrode has a porosity between 5-95%.

In a fourteenth embodiment, a method of forming a battery comprises: disposing a cathode within a housing, wherein the cathode comprises: a manganese oxide compound, wherein the manganese oxide compound has manganese in a valence state that is ≤3; a binder; and a conductive carbon; disposing an anode in the housing, wherein the cathode and the anode are separated by a separator; and disposing an electrolyte in the housing.

A fifteenth embodiment can include the method of the fourteenth embodiment, wherein the manganese oxide compound is selected from MnO, Mn₃O₄, Mn₂O₃, MnOOH, Mn(OH)₂, XMn₂O₄ (where X=Li, Zn, Cu, Al, H) including α, β, γ, λ, ∈, δ polymorphs t, and combinations thereof.

A sixteenth embodiment can include the method of the fourteenth or fifteenth embodiment, wherein the one or more additives are in oxide form, hydroxide form, or elemental form.

A seventeenth embodiment can include the method of the sixteenth embodiment, wherein the one or more additives are selected from the group consisting of bismuth oxide, bismuth hydroxide, copper oxide, copper hydroxide, cobalt hydroxide, lead oxide, silver oxide, nickel oxide, nickel hydroxide, lithium hydroxide, aluminum hydroxide, barium hydroxide, nickel, copper, bismuth, cobalt.

An eighteenth embodiment can include the method of any one of the fourteenth to seventeenth embodiments, wherein the at least one additive of the one or more additives is in powder form or metallic support form.

A nineteenth embodiment can include the method of the eighteenth embodiment, wherein the metallic support form is a mesh, a foil, a ingot, or a wire.

A twentieth embodiment can include the method of any one of the fourteenth to nineteenth embodiments, wherein the one or more additives comprise bismuth oxide, bismuth hydroxide, or elemental bismuth.

A twenty first embodiment can include the method of any one of the fourteenth to twentieth embodiments, wherein the one or more additives form an additive layer, wherein the manganese oxide is disposed in an active material layer, and wherein the additive layer is in contact with the active material layer.

A twenty second embodiment can include the method of the twenty first embodiment, wherein the additives layer comprises 1-95 wt. % bismuth oxide, bismuth hydroxide, or bismuth, and 5-99 wt. % of a binder, supporting materials, or both.

A twenty third embodiment can include the method of the twenty first or twenty second embodiment, wherein the active material layer comprises supporting materials, and wherein the supporting materials comprise carbon, calcium hydroxide, magnesium hydroxide, nickel hydroxide, titanium dioxide, or cobalt oxide.

A twenty fourth embodiment can include the method of any one of the fourteenth to twenty third embodiments, wherein the conductive carbon comprises graphite, carbon black, acetylene black, single walled carbon nanotubes, multi-walled carbon nanotubes, single and multi-walled carbon nanotubes coated with nickel or copper, graphene, graphyne, graphene oxide, or any combination thereof.

A twenty fifth embodiment can include the method of any one of the fourteenth to twenty fourth embodiments, wherein the electrode consists essentially of greater than 0 wt. % and less than or equal to 99 wt. % of the manganese oxide compound; greater than 0 wt. % and less than or equal to 99 wt. % the conductive carbon; and the balance being the one or more additive.

A twenty sixth embodiment can include the method of any one of the fourteenth to twenty fifth embodiments, wherein the electrode has a porosity between 5-95%.

A twenty seventh embodiment can include the method of any one of the fourteenth to twenty sixth embodiments, further comprising: charging the cathode increasing state of charge of the manganese oxide electrode to 100%.

A twenty eighth embodiment can include the method of any one of the fourteenth to twenty seventh embodiments, further comprising: cycling the cathode between ≥0.2V and ≤1V vs Hg|HgO and −1V vs Hg|HgO a plurality of time; and increasing the capacity of the battery to at least 600 mAh/g-MnO based on the cycling.

In a twenty ninth embodiment, a method for charging a battery comprises: charging a battery, wherein the battery comprises an initial capacity, and wherein the batter comprises: a manganese oxide cathode, wherein the manganese oxide compound has manganese in a valence state that is ≤3; a counter-electrode; a reference electrode; a separator; and an electrolyte; and increasing a capacity of the battery from the initial capacity to a final capacity, wherein the initial capacity is less than the final capacity, and wherein the final capacity is at least 600 mAh/g-MnO.

A thirtieth embodiment can include the method of the twenty ninth embodiment, wherein the counter-electrode is zinc, zinc oxide, aluminum, aluminum oxide, lithium, magnesium, iron, iron hydroxide, nickel, nickel hydroxide, tin, tin oxide, bismuth, bismuth oxide, potassium, selenium, cobalt, cobalt oxide, titanium, titanium oxide or combinations thereof.

A thirty first embodiment can include the method of the twenty ninth or thirtieth embodiment, wherein the reference electrode is mercury(Hg)|Mercury oxide(HgO), standard hydrogen electrode, mercury|mercury chloride, or silver|silver chloride.

A thirty second embodiment can include the method of any one of the twenty ninth to thirty first embodiments, wherein the electrolyte is acidic, alkaline, ionic liquids, organic-based, solid-phase, gelled, or combinations thereof that conducts hydroxyl, protons, lithium, magnesium, aluminum, potassium, calcium and zinc ions.

A thirty third embodiment can include the method of any one of the twenty ninth to thirty second embodiments, wherein the polymeric separator comprises a polymer selected from the group consisting of a cellulose film, a sintered polymer film, a hydrophilically modified polyolefin, or combinations thereof.

A thirty fourth embodiment can include the method of any one of the twenty ninth to thirty third embodiments, wherein charging the battery comprises increasing state of charge of the manganese oxide cathode to 100%.

A thirty fifth embodiment can include the method of any one of the twenty ninth to thirty fourth embodiments, wherein increasing the capacity of the batter comprises raising the valence of manganese from ≤3 to ≥4.

A thirty sixth embodiment can include the method of any one of the twenty ninth to thirty fifth embodiments, wherein charging the battery comprises charging the cathode to ≥0.2V and ≤1V vs Hg|HgO or ≥1.5V and ≤2.5V vs Zn.

A thirty seventh embodiment can include the method of any one of the twenty ninth to thirty sixth embodiments, further comprising: discharging the battery after charging the battery, wherein discharging the battery comprises discharging the cathode −1V vs Hg|HgO or 0.3V vs Zn.

A thirty eighth embodiment can include the method of the thirty seventh embodiment, further comprising: repeating the charging and discharging until the final capacity is at least 600 mAh/g-MnO.

Embodiments are discussed below with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. An electrode comprising:
a manganese oxide compound, wherein the manganese oxide compound has manganese in a valence state that is ≤3;
one or more additives selected from the group consisting of bismuth, bismuth salt, copper, copper salt, tin, tin salt, lead, lead salt, silver, silver salt, cobalt, cobalt salt, nickel, nickel salt, magnesium, magnesium salt, aluminum, aluminum salt, potassium, potassium salt, lithium, lithium salt, calcium, calcium salt, gold, gold salt, antimony, antimony salt, iron, iron salt, barium, barium salt, zinc and zinc salt; and
a conductive carbon.

2. The electrode of claim 1, wherein the manganese oxide compound is selected from MnO, Mn₃O₄, Mn₂O₃, MnOOH, Mn(OH)₂, XMn₂O₄ (where X=Li, Zn, Cu, Al, H) including α, β, γ, λ, ∈, δ polymorphs t, and combinations thereof.

3. The electrode of claim 1, wherein the one or more additives are in oxide form, hydroxide form, or elemental form.

4. The electrode of claim 3, wherein the one or more additives are selected from the group consisting of bismuth oxide, bismuth hydroxide, copper oxide, copper hydroxide, cobalt hydroxide, lead oxide, silver oxide, nickel oxide, nickel hydroxide, lithium hydroxide, aluminum hydroxide, barium hydroxide, nickel, copper, bismuth, cobalt.

5. The electrode of claim 1, wherein the at least one additive of the one or more additives is in powder form or metallic support form.

6. The electrode of claim 5, wherein the metallic support form is a mesh, a foil, a ingot, or a wire.

7. The electrode of claim 1, wherein the one or more additives comprise bismuth oxide, bismuth hydroxide, or elemental bismuth.

8. The electrode of claim 1, wherein the one or more additives form an additive layer, wherein the manganese oxide is disposed in an active material layer, and wherein the additive layer is in contact with the active material layer.

9. The electrode of claim 8, wherein the additives layer comprises 1-95 wt. % bismuth oxide, bismuth hydroxide, or bismuth, and 5-99 wt. % of a binder, supporting materials, or both.

10. The electrode of claim 8, wherein the active material layer comprises supporting materials, and wherein the supporting materials comprise carbon, calcium hydroxide, magnesium hydroxide, nickel hydroxide, titanium dioxide, or cobalt oxide.

11. The electrode of claim 1, wherein the conductive carbon comprises graphite, carbon black, acetylene black, single walled carbon nanotubes, multi-walled carbon nanotubes, single and multi-walled carbon nanotubes coated with nickel or copper, graphene, graphyne, graphene oxide, or any combination thereof.

12. The electrode of claim 1, wherein the electrode consists essentially of greater than 0 wt. % and less than or equal to 99 wt. % of the manganese oxide compound; greater than 0 wt. % and less than or equal to 99 wt. % the conductive carbon, and the balance being the one or more additive.

13. The electrode of claim 1, wherein the electrode has a porosity between 5-95%.

14. A method of forming a battery, the method comprising:
disposing a cathode within a housing, wherein the cathode comprises:
a manganese oxide compound, wherein the manganese oxide compound has manganese in a valence state that is ≤3;
a binder; and
a conductive carbon;
disposing an anode in the housing, wherein the cathode and the anode are separated by a separator; and
disposing an electrolyte in the housing.

15. The method of claim 14, wherein the manganese oxide compound is selected from MnO, Mn₃O₄, Mn₂O₃, MnOOH, Mn(OH)₂, XMn₂O₄ (where X=Li, Zn, Cu, Al, H) including α, β, γ, λ, ∈, δ polymorphs t, and combinations thereof.

16. The method of claim 14, wherein the one or more additives are in oxide form, hydroxide form, or elemental form.

17. The method of claim 16, wherein the one or more additives are selected from the group consisting of bismuth oxide, bismuth hydroxide, copper oxide, copper hydroxide, cobalt hydroxide, lead oxide, silver oxide, nickel oxide, nickel hydroxide, lithium hydroxide, aluminum hydroxide, barium hydroxide, nickel, copper, bismuth, cobalt.

18. The method of claim 14, wherein the at least one additive of the one or more additives is in powder form or metallic support form.

19. The method of claim 18, wherein the metallic support form is a mesh, a foil, a ingot, or a wire.

20. The method of claim 14, wherein the one or more additives comprise bismuth oxide, bismuth hydroxide, or elemental bismuth.

21. The method of claim 14, wherein the one or more additives form an additive layer, wherein the manganese oxide is disposed in an active material layer, and wherein the additive layer is in contact with the active material layer.

22. The method of claim 21, wherein the additives layer comprises 1-95 wt. % bismuth oxide, bismuth hydroxide, or bismuth, and 5-99 wt. % of a binder, supporting materials, or both.

23. The method of claim 21, wherein the active material layer comprises supporting materials, and wherein the supporting materials comprise carbon, calcium hydroxide, magnesium hydroxide, nickel hydroxide, titanium dioxide, or cobalt oxide.

24. The method of claim 14, wherein the conductive carbon comprises graphite, carbon black, acetylene black, single walled carbon nanotubes, multi-walled carbon nanotubes, single and multi-walled carbon nanotubes coated with nickel or copper, graphene, graphyne, graphene oxide, or any combination thereof.

25. The method of claim 14, wherein the electrode consists essentially of greater than 0 wt. % and less than or equal to 99 wt. % of the manganese oxide compound; greater than 0 wt. % and less than or equal to 99 wt. % the conductive carbon, and the balance being the one or more additive.

26. The method of claim 14, wherein the electrode has a porosity between 5-95%.

27. The method of claim 14, further comprising:
charging the cathode increasing state of charge of the manganese oxide electrode to 100%.

28. The method of claim 14, further comprising:
cycling the cathode between ≥0.2V and ≤1V vs Hg|HgO and −1V vs Hg|HgO a plurality of time; and
increasing the capacity of the battery to at least 600 mAh/g-MnO based on the cycling.

29. A method for charging a battery comprising:
charging a battery, wherein the battery comprises an initial capacity, and wherein the batter comprises:
a manganese oxide cathode, wherein the manganese oxide compound has manganese in a valence state that is ≤3;
a counter-electrode;
a reference electrode;
a separator; and
an electrolyte; and
increasing a capacity of the battery from the initial capacity to a final capacity, wherein the initial capacity is less than the final capacity, and wherein the final capacity is at least 600 mAh/g-MnO.

30. The method of claim 29, wherein the counter-electrode is zinc, zinc oxide, aluminum, aluminum oxide, lithium, magnesium, iron, iron hydroxide, nickel, nickel hydroxide, tin, tin oxide, bismuth, bismuth oxide, potassium, selenium, cobalt, cobalt oxide, titanium, titanium oxide or combinations thereof.

31. The method of claim 29, wherein the reference electrode is mercury(Hg)|Mercury oxide(HgO), standard hydrogen electrode, mercury|mercury chloride, or silver|silver chloride.

32. The method of claim 29, wherein the electrolyte is acidic, alkaline, ionic liquids, organic-based, solid-phase, gelled, or combinations thereof that conducts hydroxyl, protons, lithium, magnesium, aluminum, potassium, calcium and zinc ions.

33. The method of claim 29, wherein the polymeric separator comprises a polymer selected from the group consisting of a cellulose film, a sintered polymer film, a hydrophilically modified polyolefin, or combinations thereof.

34. The method of claim 29, wherein charging the battery comprises increasing state of charge of the manganese oxide cathode to 100%.

35. The method of claim 29, wherein increasing the capacity of the batter comprises raising the valence of manganese from ≤3 to ≥4.

36. The method of claim 29, wherein charging the battery comprises charging the cathode to ≥0.2V and ≤1V vs Hg|HgO or ≥1.5V and ≤2.5V vs Zn.

37. The method of claim 29, further comprising:
discharging the battery after charging the battery, wherein discharging the battery comprises discharging the cathode −1V vs Hg|HgO or 0.3V vs Zn.

38. The method of claim 37, further comprising:
repeating the charging and discharging until the final capacity is at least 600 mAh/g-MnO.
